(19) United States
(12) Patent Application Publication
(10) Pub. No.: US 2022/0150754 A1
(43) Pub. Date: May 12, 2022

(54) CONGESTION CONTROL PROCEDURES FOR PC5 COMMUNICATIONS

(71) Applicant: IDAC Holdings, Inc., Wilmington, DE (US)

(72) Inventors: Michelle PERRAS, Montreal (CA); Saad AHMAD, Montreal (CA)

(21) Appl. No.: 17/429,993

(22) PCT Filed: Feb. 13, 2020
(86) PCT No.: PCT/US2020/018095

§ 371 Date: Aug. 11, 2021

Related U.S. Application Data
(60) Provisional application No. 62/805,558, filed on Feb. 14, 2019.

(51) Int. Cl. H04W 28/02; H04W 76/14; H04W 76/23

(52) U.S. Cl. CPC H04W 28/0289; H04W 4/40; H04W 76/23; H04W 76/14

(57) ABSTRACT

An initiating wireless transmit receive unit (WTRU) includes circuitry configured to monitor, by the initiating WTRU, a level of congestion experienced by the initiating WTRU while communicating with the at least one peer WTRU. The initiating WTRU detects that the level of congestion triggers congestion control. The initiating WTRU transmits, based on the level of congestion, at least one message to reconfigure an ongoing communication between the initiating WTRU and the at least one peer WTRU.

### CROSS REFERENCE TO RELATED APPLICATIONS

This application claims the benefit of U.S. provisional patent application No. 62/805,558 filed 14 Feb. 2019, which is incorporated by reference herein in its entirety for all purposes.

### FIELD

The present disclosure relates to network communications, including, but not exclusively, to vehicle to everything service of a 5G communications architecture.

### BACKGROUND

Vehicle to everything (V2X) service can be part of a Fifth Generation (5G) architecture. 5G communications systems can accommodate vehicle to vehicle (V2V) and vehicle to everything (V2X) communications. Multiple types of reference point interfaces are defined in 5G specifications. However, not all communication methods are defined. The present disclosure addresses a problem in V2X communications where congestion of communications can affect V2V or V2X communications on a PC5 reference point interface between multiple user equipment (UE).

### SUMMARY

A method, apparatus, and computer-readable storage medium for addressing congestion in a wireless transmit receive unit (WTRU) in communication with a peer WTRU includes monitoring, by the initiating WTRU, a level of congestion experienced (observed locally) by the initiating WTRU while communicating with the at least one peer WTRU. The initiating WTRU detects that the level of congestion triggers congestion control. The initiating WTRU transmits, based on the level of congestion, at least one message to reconfigure an ongoing communication between the initiating WTRU and the at least one peer WTRU.

In further features, the initiating WTRU may transmit, based on the level of congestion, at least one message to reconfigure an ongoing communication by transmitting a periodic message. The periodic message may be one of a keepalive message, a privacy protection message, and/or a re-keying message. The at least one reconfiguration message can be a message to change a periodic message interval.

In another feature, the initiating WTRU may transmit the at least one message to reconfigure an ongoing communication as a message indicating a change in a quality of service (QoS). In one example, the change of a QoS can include a change of QoS parameter of a PC5 QoS Indicator (PQI) to a lower value compared to a current value.

In another feature, the reconfiguration message transmitted by the initiating WTRU may be an offloading message to relocate an ongoing communication to another communication medium. In one example, the offloading message to relocate an ongoing communication to another communication medium can include offloading the ongoing communication to another radio access technology (RAT), wherein the initiating WTRU and at the least one peer WTRU exchange access capabilities. In a further feature, the offloading message can include a list of RATs specific to a vehicle to everything (V2X) service or V2X application in a preferred order.

In another feature, the initiating WTRU can transmit a release message of an ongoing communication between the initiating WTRU and the at least one peer WTRU. In yet another feature, the initiating WTRU can transmit a reject message of an incoming communication request received at the initiating WTRU from one peer WTRU.

Although various embodiments are described and/or claimed herein in which an apparatus, system, device, etc. and/or any element thereof carries out an operation, process, algorithm, function, etc. and/or any portion thereof, it is be understood that any embodiments described and/or claimed herein assume that any apparatus, system, device, etc. and/or any element thereof is configured to carry out any operation, process, algorithm, function, etc. and/or any portion thereof. Unless otherwise stated explicitly herein, a feature of one embodiment may be combined with another embodiment. Additionally, embodiments and/or features of embodiments may be combined to achieve further advantageous results.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals (“ref.”) in the Figures indicate like elements, and wherein:

FIG. 1A is a system diagram illustrating an example communications system in which one or more disclosed embodiments may be implemented;

FIG. 1B is a system diagram illustrating an example WTRU that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 depicts a signal diagram for a V2X Service oriented layer 2 link establishment procedure between peer WTRUs;

FIG. 3 depicts a signal diagram for a WTRU oriented layer 2 link establishment procedure;

FIG. 4 depicts an example signal diagram showing an interested WTRU initiating the link establishment procedure;

FIG. 5 depicts a signal diagram showing a determination of which WTRU handles communication link reconfiguration;

FIG. 6 depicts a signal diagram showing a direct communication release message with back-off timer;

FIG. 7 depicts a signal diagram showing a direct communication reject message with back-off timer;

FIG. 8 depicts a signal diagram showing unicast link interval reconfiguration based on received congestion level from a peer WTRU;

FIG. 9 depicts a signal diagram showing unicast link interval reconfiguration based on detected congestion level;

FIG. 10 depicts a signal diagram showing radio access technology offloading due to a congestion control using a release message;

FIG. 11 depicts a signal diagram showing radio access technology offloading due to a congestion control using a reject message; and

FIG. 12 depicts a signal diagram showing radio access technology offloading due to a congestion control using a keepalive message.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application. In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein.

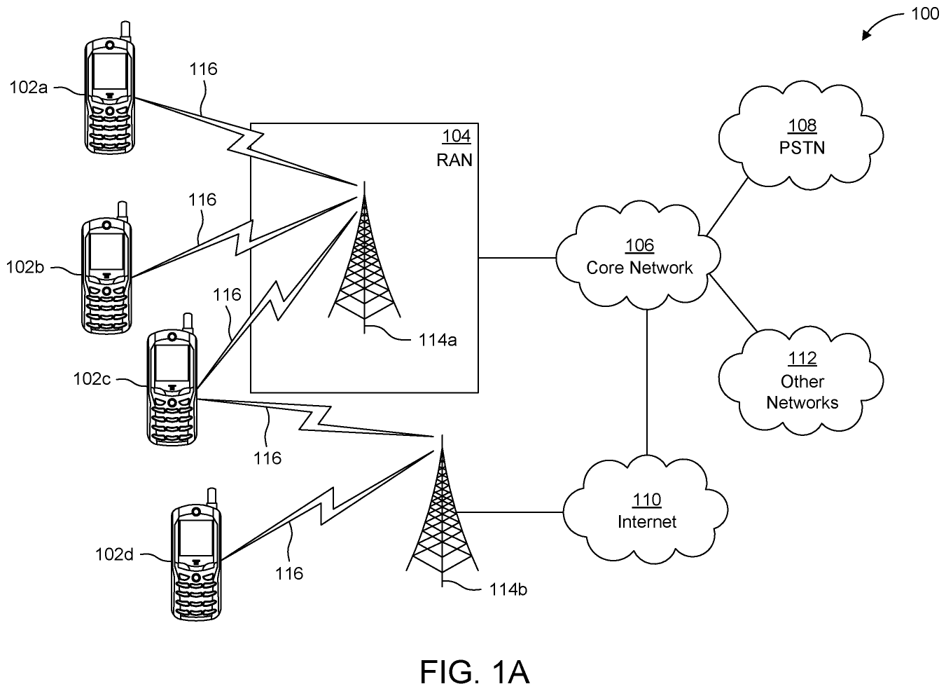

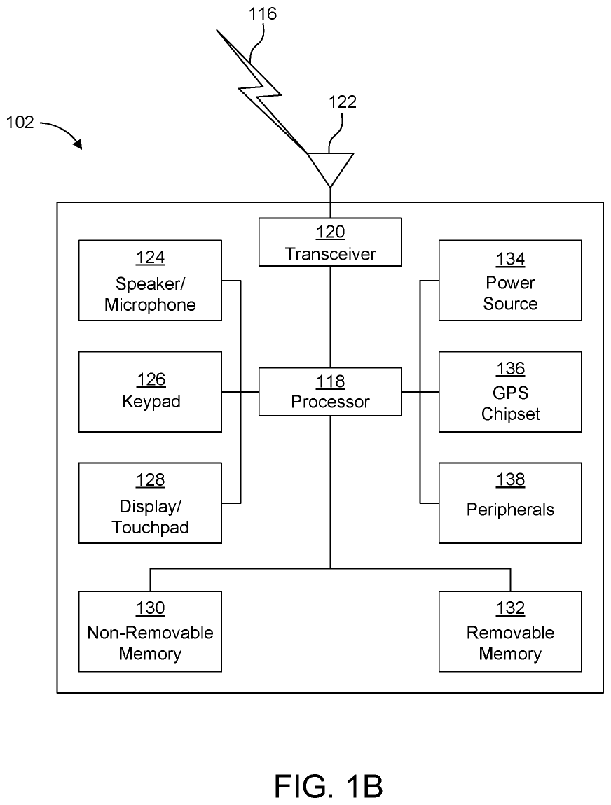

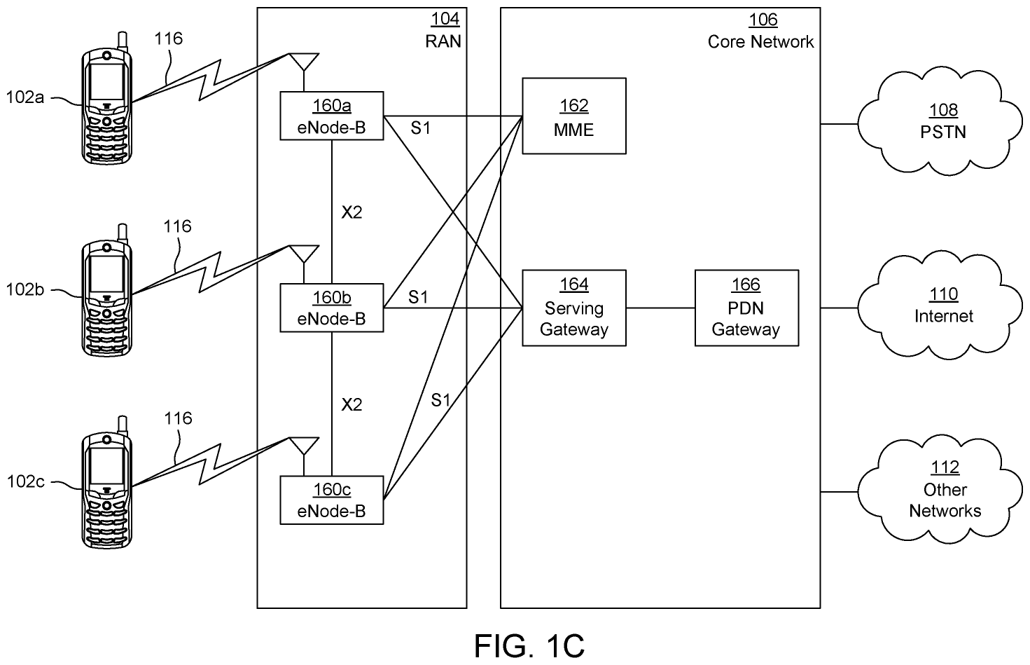

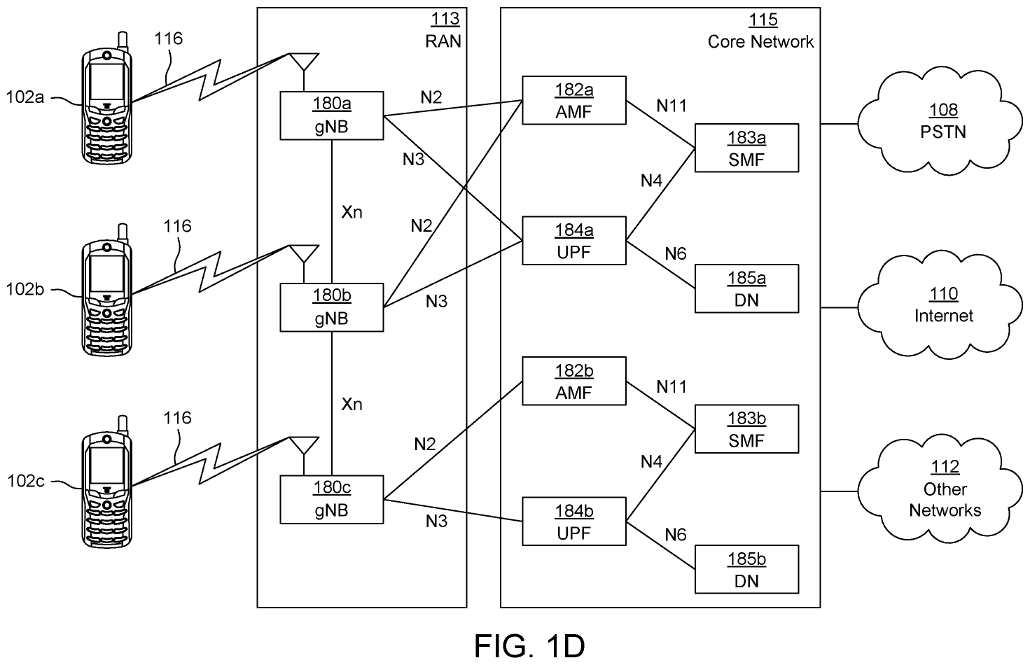

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the Si interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of (non-access stratum) (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU/UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

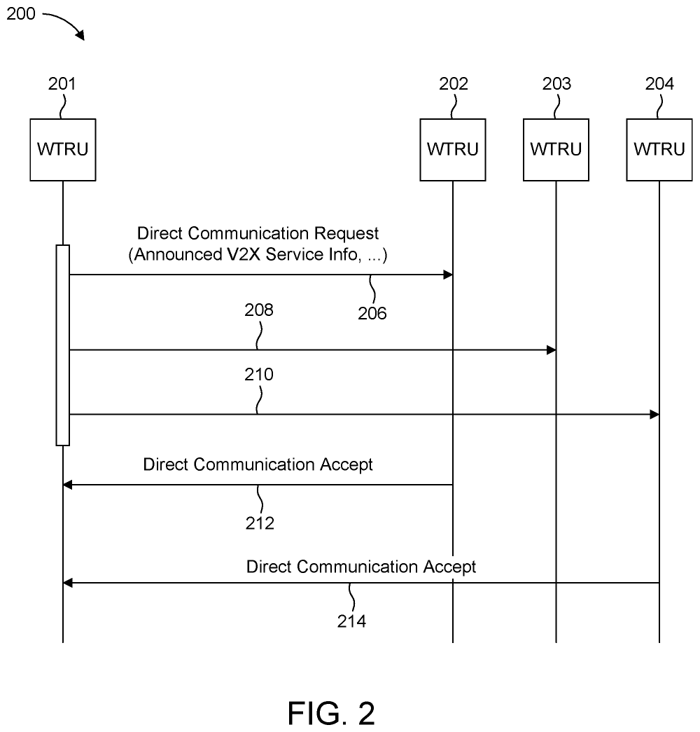

As explained herein, a wireless transmit receive unit (WTRU) may be an example of a user equipment (UE). Hence the terms UE and WTRU may be used in equal scope herein. A V2X Service oriented layer 2 link establishment procedure is illustrated in FIG. 2. Referring to FIG. 2, the Direct Communication Request (DCR) message 206, 208, 210 may be sent by WTRU 201 with a broadcast mechanism, i.e. to a broadcast address associated with the application, such as a V2V or V2X application. The broadcast message may be received by other WTRUs including WTRU 202, WTRU 203, and WTRU 204. The information concerning a V2X Service requesting a layer 2 (L2) link establishment, (i.e. information about the announced V2X Service) may be included in the Direct Communication Request message to allow other (peer) WTRUs to decide whether to respond to the request or not. All WTRUs that are interested in using the V2X Service announced by the Direct Communication Request (DCR) message may respond to the request. For example, WTRU 202 in FIG. 2 responds to the DCR broadcast message with a Direct Communication Accept (DCA) message 212. WTRU 204 in FIG. 2 responds to the DCR broadcast message with a DCA message 214. This V2X service-oriented link is consistent with 3GPP TR 23.786 V1.1.0 (2019-01), Study on architecture enhancements for EPS and 5G System to support advanced V2X services (Release 16).

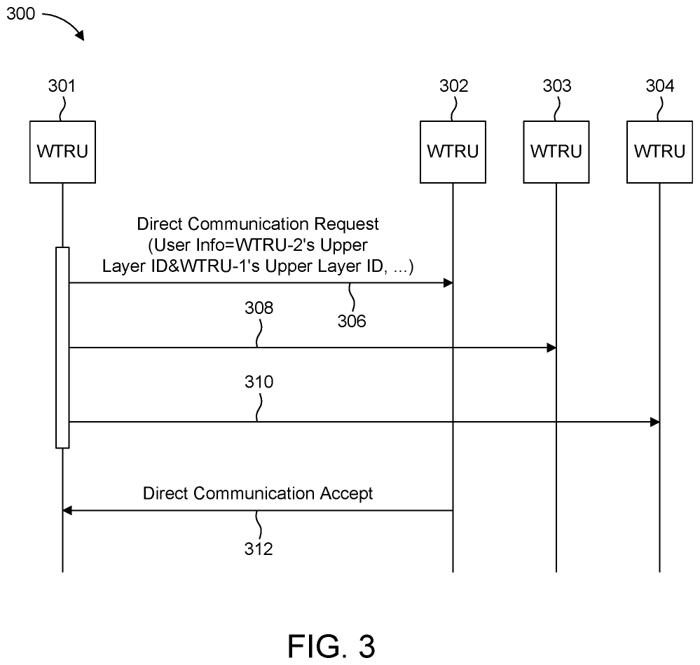

A WTRU oriented layer 2 link establishment procedure is illustrated in FIG. 3. The Direct Communication Request message 306, 308, 310 can be sent by WTRU 301 with broadcast mechanism, i.e. to a broadcast address associated with the application, such as to WTRU 302, WTRU 303, WTRU304. The upper identifier (e.g. upper layer ID) of WTRU 302 is included in the Direct Communication Request message to allow WTRU 302 to decide whether to respond to the request. A Direct Communication Accept (DCA) message 312 may be sent by WTRU 302 to respond to the DCR message 306.

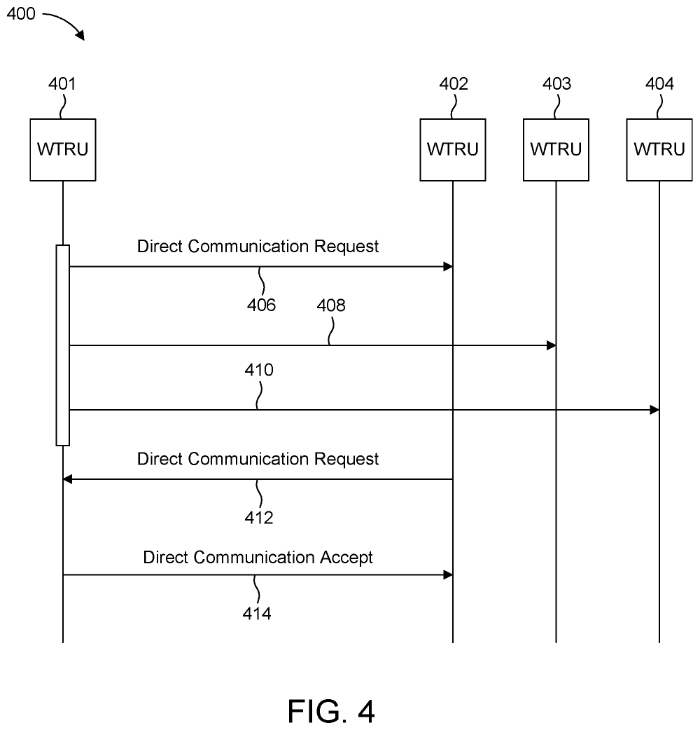

An alternative link establishment procedure may be possible where each WTRU, upon receiving the DCR message from the initiating WTRU (i.e. WTRU 301), may be interested in an announced V2X service. The interested WTRU may then initiate a unicast link establishment procedure by sending its own DCR message to the initiating WTRU. In one alternative link establishment, peer WTRUs do not reply to DCR message from the initiating WTRU. This procedure is shown in FIG. 4. Here, an interested WTRU initiates the link establishment message. Although unicast communication is used as an example PC5 communication at steps 406, 408, 410, other types of PC5 communications can equally be employed between WTRUs. For example, if a broadcast discovery message, is sent instead of a DCR message, then a peer WTRU may learn the WTRU 401 L2 ID and establish the PC5 link as shown at steps 412, 414.

An initiating WTRU (e.g. WTRU 401) may broadcast supported V2X service on a PC5 radio access technology (RAT), such as a 5G PC5 reference point interface via broadcast DCR message 406, 408, 410. Many WTRUs may be interested in such a V2X service and may establish a communication with the initiating WTRU. As well, many V2X services may be announced, thus a WTRU may end-up having multiple communications concurrently running, to maintain and generate and/or receiving data. In addition to that, a unicast communication may be established with a specific WTRU, adding to the number of established communications, usage of resources, etc. In one example, interested WTRU 2 sends a DCR message 412 to initiating WTRU 401 which can then respond with a DCA message 414.

It can be appreciated that having many ongoing communications on a WTRU may lead to congestion conditions on the WTRU and/or on the RAT. Therefore, peer WTRUs may experience lower quality communication. That is, quality of service (QoS) requirements may not be meet for some V2X applications. In a severe instance, communication may even be lost over the PC5 interface. Moreover, losing communication due to congestion conditions may result in peer WTRUs trying to re-establish the link thus creating even more congestion on the RAT and on the WTRU. Finally, multiple WTRUs may reply and establish a unicast link with the initiator WTRU. Congestion due to too many unicast communications established on the initiating WTRU may occur. Thus, a technique to address congestion of a WTRU is desirable.

Note that V2X used in this disclosure merely serves as an example of communications. The procedures defined herein may apply to other types of communications, for example, communication with other electronics devices such as drones, trains, and maritime communication. Herein is described is set of actions that may be taken by a WTRU to address the problem of congestion. Any or all of the set of actions may be taken to address or otherwise reduce or isolate congestion. A WTRU may manage congestion by dynamically controlling its resources usage. Such dynamic control actions may include releasing existing communications or rejecting new communication requests. Other dynamic control actions may be adapting existing communications, such as reducing the control plane traffic, changing the required QoS, or offloading communications to another RAT.

According to one novel feature, an initiating WTRU may advertise its congestion level when initiating a unicast link establishment or during an ongoing PC5 unicast communication. A congestion level that is transmitted/advertised to other WTRUs is a congestion level that the transmitting WTRU is experiencing or is known to the transmitting WTRU. This transmittal/advertisement of a congestion level by a transmitting WTRU enables the interested peer or receiving WTRUs to decide, based on the congestion information, whether they should reply to the link establishment from the initiating WTRU or whether they should choose to ignore this link establishment request and wait for the congestion to resume, or reduce, or wait for the appearance of another initiating WTRU supporting the same service that is less congested.

Since the congestion level is changing all the time, it may be advertised multiple ways or times or periodically. Such as, for example, when initiating unicast link establishment, during keepalive, privacy protection and re-keying procedures. Any periodic message transmitted by a WTRU is a candidate for inclusion of a congestion level or status information. Due to congestion, an initiating WTRU may reject a communication establishment request from another WTRU, or it may release an ongoing unicast communication. In both cases, a back-off interval may be specified on the release and reject messages along with the appropriate cause code indicating the reason for rejection is due to congestion. Hence, the peer WTRU need not immediately retry to (re)establish the communication. A back-off timer, per peer layer 2 identifier (L2 ID), is used on the peer WTRU. The back-off timer may also be per L2 ID and V2X application ID Intelligent Transportation System-Application Identifier (ITS-AID) Provider service Identifier (PSID), i.e. associated to the initiating WTRU's L2 ID and potentially to the V2X application as well.

When congestion is observed on a link, the initiating WTRU may reduce the amount of traffic exchanged on the signaling plane to limit the congestion. For example, the keepalive interval may be increased for some time. The privacy protection interval and re-keying interval may be increased as well. Furthermore, the initiating WTRU may change the requested QoS of the link if congestion is observed (or if congestion is not observed anymore). New QoS values may be specified e.g. to increase the acceptable latency.

Another possibility when congestion is observed is to offload the communication to another RAT. Offloading effectively relocates traffic from one communication medium/access to another communication medium/access. For example, a communication over Fifth Generation/New Radio PC5 5G/NR PC5 may be offloaded to long term evolution (LTE) PC5 for some length of time. This action may be taken if the LTE PC5 is less congested at that time of congestion of the WTRU. The reverse may be done as well. That is, moving the LTE PC5 to the 5G/NR PC5. To enable this offloading, the initiating WTRU and peer WTRU may need to exchange their capabilities. In that instance, only unicast communications with both WTRUs supporting LTE and 5G versions of PC5 may be offloaded.

A WTRU may be provisioned with QoS profiles mapping to congestion levels and with congestion control features enabled or disabled. Additionally, congestion thresholds may be configured so that the WTRU knows when congestion is too high and congestion control may be applied or when congestion is low enough to undo congestion control measures. Reversing congestion control measures may include reconfiguring the intervals to normal values, accepting new communication establishment again, and the like. Although many of the procedures in this document are described from the perspective of interactions between the WTRUs from the V2X layer/NAS layer/ProSe layer or upper layers, the same procedures may be applicable at the RRC signaling exchange between the WTRUs.

According to a novel feature, congestion detection for a WTRU operating on a PC5 RAT is based on link measurements. The access stratum (AS) layer handles the link measurements and may be aware of the link congestion. The AS layer may send an indication to the V2X layer to inform it of congestion conditions (on/off) on a specific RAT. A level of congestion may also be specified by the AS layer. Another possibility includes the AS layer providing measurement information to the V2X layer which itself determines if congestion conditions arise. In any case, it is assumed that the V2X layer can become aware of congestion conditions.

The congestion on or associated with the WTRU may be also considered as affected by such conditions as the number of ongoing communications, memory usage, CPU usage, and the like. Congestion on the WTRU may be monitored by the V2X layer (or another layer interfacing with the V2X layer) and may be based on provisioning within a WTRU. For example, a maximum number of ongoing communications may be taken into consideration when determining the presence of congestion on a WTRU.

In the instance of a unicast communication between two WTRUs, both WTRUs may monitor and handle congestion or only one of them may handle it. That is, both WTRUs may monitor their resources usage, advertise their congestion level, release existing communications and/or reject new communication requests. However, one WTRU may be selected to handle reconfiguration of an existing communication.

For example, during the communication establishment, WTRUs may determine which one is responsible of handling the communication reconfiguration. The initiating WTRU may request the responsibility and the responding WTRU allows the allocation of responsibility. Alternately, the responding WTRU may request the responsibility. The responding WTRU may be the one which takes the final decision, or the responding WTRU may be pre-determined to have and maintain the reconfiguration responsibility. A WTRU may have this responsibility of reconfiguring a specific communication, whereas, for another communication, a peer WTRU has this responsibility.

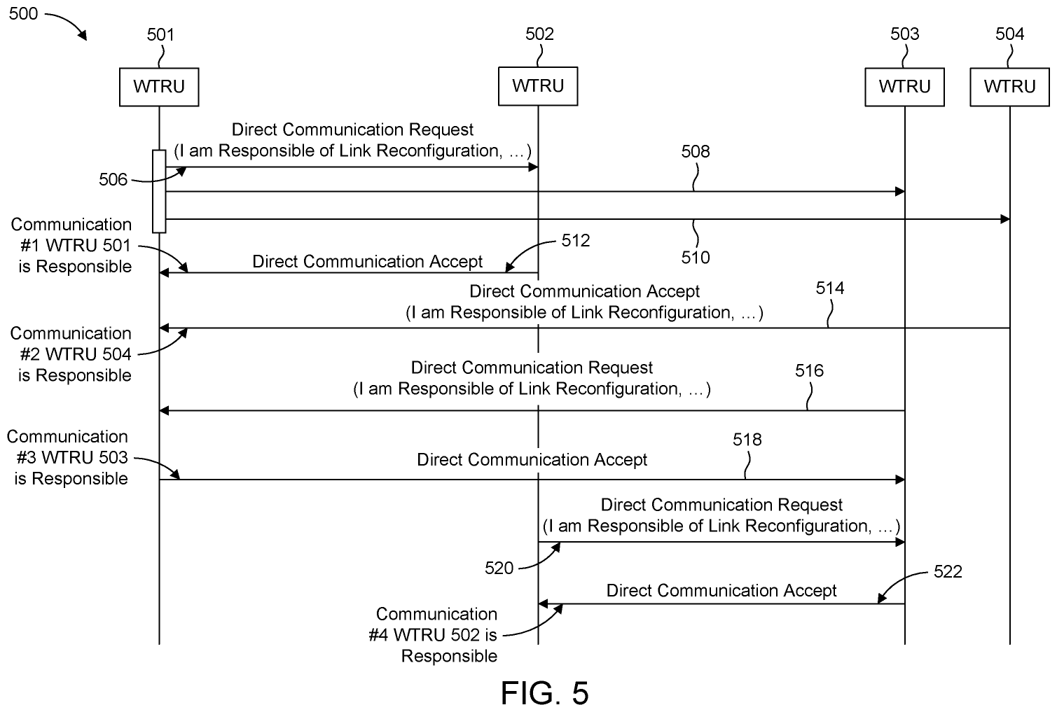

FIG. 5 illustrates examples of how WTRUs may determine which one is responsible for handling communication reconfiguration. These examples are based on the three methods for unicast link establishment previously described. In the specific example shown in FIG. 5, WTRU 501 requests responsibility of handling the communication reconfiguration by using DCR message 506. WTRU 502 accepts via DCA 512 and the first communication may be established between WTRU 501 and WTRU 502 with WTRU 501 handling the reconfiguration. A second communication may be established between WTRU 501 and WTRU-4 with WTRU-4 requesting the reconfiguration responsibility using DCA message 514. Then, WTRU 503 may initiate the establishment of a communication with WTRU 501 via DCR message 516 and requests the handling of reconfiguration. A third communication may be established between WTRU 503 and WTRU 501 via DCA message 518. Then, WTRU 502 initiates the establishment of a communication with WTRU 503 via DCR message 520 and requests the handling of reconfiguration for this communication. A forth communication may be established between WTRU 502 and WTRU 503 via DCA message 522. Note that WTRU 502 has 2 communications (one with WTRU 501 and one with WTRU 503) and may be handling reconfiguration only for the communication with WTRU 503 (communication #4). WTRU 501 handles the reconfiguration for the other communication (communication #1). Alternatively, the WTRU that advertises the congestion level may implicitly be always responsible for the reconfiguration of the PC5 unicast link.

A WTRU may be configured to monitor the congestion and such WTRU may advertise its congestion level to other WTRUs in different ways, as described below. The congestion level may be advertised for example as none, low, medium, high, etc. It may be possible that the congestion level is advertised as a numerical information element (IE) in a PC5 message e.g. Congestion level IE representing congestion from integer 0-10 where 0 being no congestion and 10 being extremely high level of congestion.

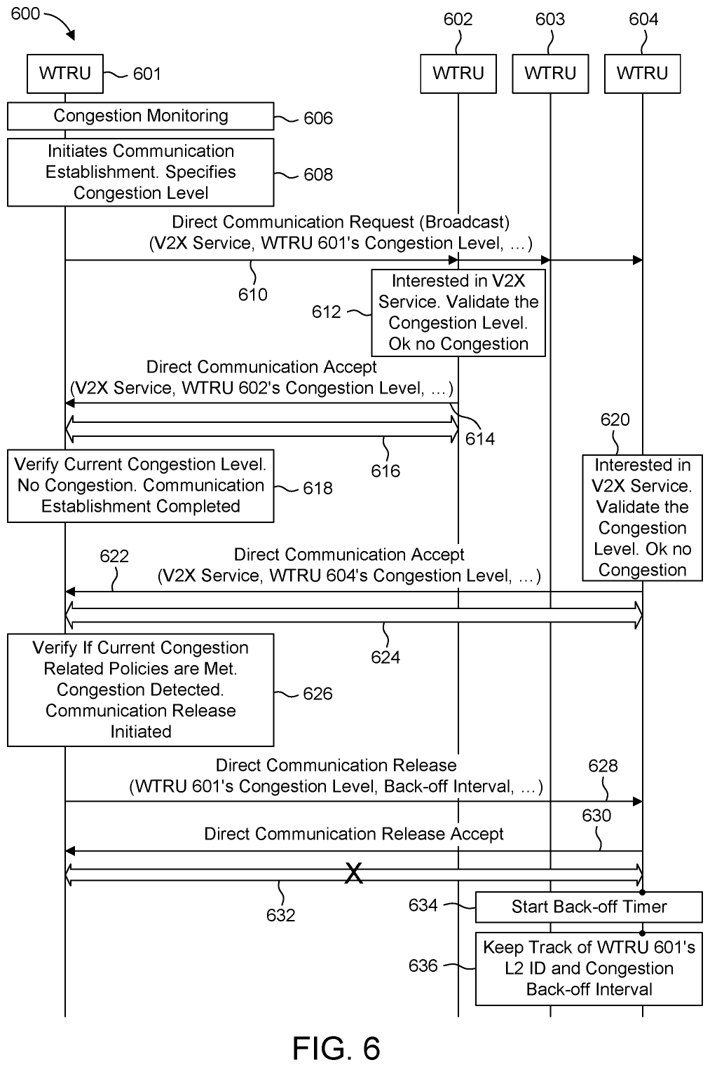

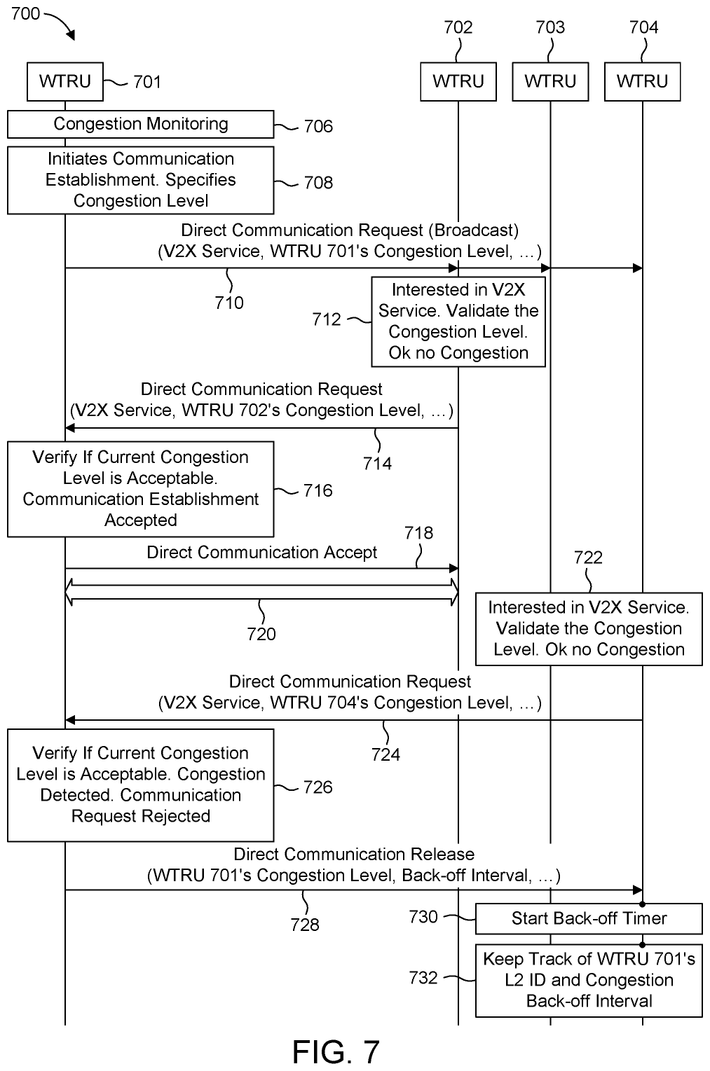

In a first example technique to advertise a congestion level, an initiating WTRU may send a DCR with a congestion level indication of the initiating WTRU. Here, no link is established at the time of DCR transmittal. Peer WTRUs receive the DCR message and if the V2X service is of interest for any one of the peer WTRUs, the peer WTRU evaluates if the received congestion level of the initiating WTRU is acceptable. That is, if the peer WTRU should establish a link with the initiating WTRU or if the peer WTRU should not establish a link due to a high congestion level which is expected to provide poor quality communication and not meet a required QoS. The initiating WTRU may advertise the congestion level on a per V2X service basis. The congestion level advertisement and communication establishment decision based on this congestion level are illustrated on FIGS. 6 and 7.

In a second example technique to advertise a congestion level, an initiating WTRU may send a Keepalive message with a congestion level indication of the initiating WTRU. Here, a link is already established between 2 peer WTRUs. A peer WTRU receiving such a Keepalive message, where the message also includes an indication that congestion is experienced, i.e. with a congestion level and a congestion indication, may apply congestion control on the existing link, as is discussed herein below. A back-off interval for periodic keepalive messages may also be specified. Furthermore, this interval may be signaling-specific. That is the interval may be applicable to session management (SM) signaling or QoS reconfiguration PC5 signaling or both.

In a third example technique to advertise a congestion level, an initiating WTRU may send a Privacy protection message with a congestion level indication of the initiating WTRU. Here, the technique is similar to that of the Keepalive message in the second example technique above. As such, a privacy protection message may contain a congestion level indication for evaluation by a peer WTRU.

In a fourth example technique to advertise a congestion level, an initiating WTRU may send a Direct rekeying request message with congestion level of the initiating WTRU. Here, the technique is similar to that of the Keepalive message in the second example technique above. As such, a direct rekeying request message may contain a congestion level indication for evaluation by a peer WTRU.

Other PC5 signaling messages (not described herein) may also be used to advertise the congestion level. It may also be possible that V2X layer or upper layer pass on the congestion level to the RRC layer. In this case, the RRC layer may advertise the congestion level over the RRC Signaling.

Congestion control procedures may be used when congestion is detected. Different congestion control procedures may be applied, depending of the situation. Incoming communication establishment requests may be rejected. Existing communication may be reconfigured, for example by changing intervals for keepalive, privacy or re-keying procedures. QoS applied to the communication may as well be reconfigured. In an instance where the congestion is too high on a specific RAT, a communication may be released or offloaded to another RAT. These various methods are detailed herein below.

In an instance where the congestion is too high, a Unicast Link Release may be exercised. In this instance, a link is already established between 2 peer WTRUs. Congestion when detected at the WTRU may trigger the release of an existing communication. How to determine which communication is going to be released may be based on various criteria or on a combination of criteria. Examples include a last established communication, such as the most recent established communication, or an activity that may be monitored on communications, such as traffic sent/received, or an inactive communication or the least active communication may be selected to be released when congestion is detected. Other criteria examples include a determination based on the number of flows, e.g. as the communication with the smallest number of flows is released, a determination based on application (ITS-AID/PSID) priority, e.g. the communication associated with the application with the lowest priority is released. Here, priorities may be provisioned per application on the WTRU. Another criterion example may be based on the PQI (PC5 QoS Indicator) and/or other QoS parameters of the different flows.

Congestion control as explained below takes as an example the V2X Service oriented method and last established communication being released. However, the unicast link release is applicable to any of the link establishment procedures discussed herein and any criteria for communication selection for releasing as described herein.

As shown in FIG. 6, congestion control may be added to the V2X Service oriented method using a direct communication release message with back off timer. The initiating WTRU (WTRU 601) monitors its congestion 606 and initiates a communication specifying its congestion level 608. WTRU 601 advertises its congestion level using the broadcast DCR message 610 to WTRU 602, 603, and 604. Peer WTRU 602 is interested in the V2X service and accepts the current congestion level and accepts the communication via DCA message 614, which includes WTRU 602 congestion level. Communications between WTRU 601 and WTRU 602 occurs at 616. WTRU 601 verifies a current congestion level, determines no congestion, and the communication establishment is completed 618.

Peer WTRU (WTRU 604) is interested in the V2X service from WTRU 601 and verifies that the congestion level is acceptable at 620. WTRU 604 establishes the link to WTRU 601 by sending a DCA message 622 and including WTRU 604 congestion level. Communication between WTRU 601 and WTRU 604 occurs at 624. Sometime later, WTRU 601 may determine that its congestion level is too high at 626. This may be determined in a variety of ways, including the congestion level crossing a threshold value or indication. When it receives the DCA message or sometime later, WTRU 601 terminates the link with WTRU 604 by sending a Direct Communication Release message 628. A back-off interval may also be specified on this message. The back-off interval is sent to indicate to the peer WTRU (WTRU 604) the waiting time before trying to re-establish the link. WTRU 604 responds by sending a direct communication release accept message 630 and the communication 632 between WTRU 601 and WTRU 604 terminates.

The peer WTRU (WTRU 604) starts a back-off timer at 634 using the value specified on the release message 628 when receiving a Direct Communication Release which specifies a back-off interval. This back-off timer and associated interval value is per L2 ID, that is, per unicast communication. It may also be per L2 ID and V2X Service. WTRU 604 keeps track of L2 ID and the back-off interval association at 634, and possibly of the related V2X Service. At the back-off timer expiration, WTRU 604 may try to re-establish the communication with WTRU 601 by sending a DCR message using the L2 ID associated with the back-off timer. WTRU 604 may validate that the congestion level on its side is acceptable before trying to re-establish the communication. If the congestion level is still determined to be too high, the back-off timer is re-started and no attempt to re-establish the communication is attempted. While this back off timer is running at WTRU 604, the WTRU 604 may still try to establish the PC5 Direct Communication with a different WTRU which is advertising the same service and has a lower congestion level. If WTRU 604 is successfully able to establish a PC5 unicast connection with the different WTRU providing the same service, the WTRU 604 may stop the back-off timer.

Peer WTRU (WTRU 604) may also evaluate WTRU 601's congestion level by keeping track of a recent congestion level advertisement received from WTRU 601. For example, initiating WTRU 601 may advertise a supported V2X service by periodically producing broadcast messages, such as a DCR, which includes its current congestion level. WTRU 601 may also broadcast a DCR, which includes its congestion level, using the WTRU-oriented method. Even if this message is not destined to WTRU 604 or if WTRU 604 is not interested in the broadcasted V2X service, WTRU 604 may still keep track of WTRU 601's congestion level included in the broadcasted message (not shown in FIG. 6).

WTRU 604 may keep track of the WTRU-601 congestion level if a back-off timer is running for on this specific WTRU (i.e. WTRU-601) and optionally this specific V2X service. At back-off timer expiration, WTRU 604 may consider the saved WTRU-601's congestion level and decide to send another DCR or not, depending if there is still congestion or not. If the decision is to not send a DCR, the back-off timer is restarted. The saved congestion level may be kept with a timestamp (from the broadcast message), to make sure that it is still accurate. This is done in the instance where the the broadcast interval on WTRU-601 is long and the interval is long enough for the congestion to clear out.

Another procedure for congestion control is Unicast Link Establishment Rejection. In this congestion control procedure, a link establishment exists and may be ongoing between 2 peer WTRUs. The link establishment method used may be any of the techniques for link establishment previously described. The initiating WTRU broadcasts a DCR message specifying a V2X service. Interested peer WTRUs reply by initiating the establishment procedure, such as sending a DCR message to the initiating WTRU.

FIG. 7 is an example of direct communication reject message with back-off timer. WTRU 701 performs congestion monitoring at 706 and initiates a communication establishment message that also specifies a congestion level at 708. In the Unicast Link Establishment Rejection procedure of FIG. 7, the initiating WTRU (WTRU 701) includes the congestion level on the broadcasted DCR message 710 to peer WTRU 702, WTRU 703, and WTRU 704. Peer WTRUs (WTRU 702 and WTRU 704) are interested by the V2X service and consider if the congestion level is acceptable at 712 and 722 respectively. That is, the received congestion level on the broadcast message from WTRU 702 and the congestion level on the peer WTRU side WTRU 702 and WTRU 704 may be evaluated, if the peer WTRUs are monitoring their own congestion. If no adverse congestion is determined, WTRU 702 and WTRU 704 send back a DCR message to WTRU 701, specifying their congestion level.

WTRU 701 receiving such a DCR message 714, from WTRU 702 for example, evaluates the congestion level experienced by the WTRU 701 at this moment and may consider the congestion level specified on the received DCR message from the peer WTRUs at 716 and, if the congestion level is determined as acceptable then WTRU 701 accepts the communication by sending a DCA message 718 to WTRU 702. Communication is established between WTRU 701 and WTRU 702 at 720.

On the other hand, at reception of DCR from WTRU 704, congestion conditions have worsened and WTRU 701 determines that the congestion level at WTRU 701 is not acceptable at 726, so it rejects the link establishment request by sending a Direct Communication Reject message 728 to WTRU 704. A back-off interval is specified on the reject message. Communication is thus not established between WTRU 701 and WTRU 704.

At reception of a Direct Communication Reject message 728, which includes a back-off interval, WTRU 704 starts a back-off timer at 730 using the interval specified on the release message. This back-off timer is associated to the interval value and L2 ID of WTRU 701. That is, WTRU 704 keeps track of L2 ID and the back-off interval association at 732. At the back-off timer expiration, WTRU 704 may try again to establish the communication with WTRU 701 by sending a DCR message using the L2 ID associated with the back-off timer. WTRU 704 may validate that the congestion level on its side is acceptable before trying to establish the communication. If the congestion level is determined to be too high (i.e. not acceptable), the back-off timer is re-started and no attempt to establish the communication is attempted.

As described with the unicast link release procedure, a peer WTRU, such as WTRU 704, may also evaluate WTRU 701's congestion level by keeping track of recent advertisements of congestion received from WTRU 701. WTRU 704 may keep track of this congestion level if a back-off timer is running for on this specific WTRU (i.e. WTRU 701) and optionally this specific V2X service. At the back-off timer expiration, WTRU 704 may consider the saved WTRU 701's congestion level and decide to send another DCR or not, depending if there is still congestion or not. If the decision is to not send a DCR, the back-off timer is restarted. The WTRU 701 saved congestion level may be kept with a timestamp (from the broadcast message), to make sure that it is still accurate. This is done in case the broadcast interval on WTRU 701 is long enough for the congestion to clear out.

Yet another procedure for congestion control is Unicast Link Reconfiguration. In some instances, congestion may be detected, and a WTRU may decide to reconfigure existing communications to limit the amount of signaling traffic sent until congestion clears out. As well, requested QoS may be modified to try to adapt to the existing conditions. These reconfigurations are described in more details herein below.

One reconfiguration resulting from a congestion condition that may be taken is QoS. The QoS profile associated to V2X Applications may be provisioned on the WTRU, as later described herein. Depending of the congestion conditions, a new QoS profile, which may describe priority, latency, and the like, and Range, the minimum distance that the QoS parameters need to be fulfilled, may be applied to adapt to the actual conditions. V2X peers may agree on the QoS profile and Range to be applied when congestion is detected, using signaling messages, such as the keepalive procedure or a different PC5 Signaling procedure, may be triggered specifying the new QoS profile and Range to be applied and the current congestion level.

Another possibility may be to advertise the QoS profiles and Range per congestion level during the communication establishment, that is, when sending the Direct Communication Request message. A new QoS profile and Range may then be applied each time a new congestion level with a corresponding QoS profile is advertised.

The V2X layer may configure the AS layer, based on the QoS profile and Range information exchanged between the peer WTRUs. During the setup of the link, QoS parameters are generally exchanged. The negotiated QoS may then be applied to the PC5 unicast link. The WTRU may exchange/negotiate possible QoS levels during the PC5 link establishment. Once agreed upon between the WTRUs, at the time of congestion, the WTRU may implicitly reduce the QoS of the PC5 link by changing the QoS parameters of the link, such as QFI, 5QI, PC5 QoS indicator (PQI) to a lower agreed upon value. The change to the lower QoS value may be based on the level of congestion experienced and/or advertised over the link. For example, the WTRUs (initiating WTRU and Peer WTRU) may negotiate three different PQIs during the PC5 link establishment. An example may be a PQI with a, b, and c, where “a” may be the highest and “c” may be being the lowest. The traffic over this PC5 link may be sent with PQI a at the time no congestion, may be with PQI b at low-medium congestion level and PQI c at the high congestion levels. The WTRU implicitly changes the PQI based on the advertised/observed level of congestion.

It may be further possible that when the congestion level is advertised using one of the methods described earlier, the WTRU may further include an indication that QoS signaling and/or SM signaling is not allowed. Hence, the WTRUs may refrain from sending any PC5 signaling to reconfigure the QoS of the PC5 link when such indication is sent by the congested WTRU. Such action may also be implicitly taken by the WTRU based on the observed/advertised congestion level. Further when the WTRU receives a back off interval during the congestion (e.g. on a Keepalive message), the associated timer may be specific to the SM signaling and/or QoS reconfiguration PC5 signaling. If specific to QoS signaling, then no QoS signaling traffic may be sent during the specified interval.

A second reconfiguration resulting from a congestion condition that may be taken may be setting intervals for periodic messages such as Keepalive, or Privacy, or Re-Keying, and the like. Basic procedures for keepalive, privacy protection and re-keying already exist. These procedures are repeated periodically. That is, signaling messages are exchanged at specific intervals between 2 peers. To limit the congestion at an initiating WTRU or a peer WTRU, it may be desirable to reduce the signaling messages that are sent per existing communication. This may be done by increasing the intervals based on the observed congestion conditions. As a novel feature, a congestion level is added to the messages described herein above. In addition, a new congestion indication is added, and the interval value is reconfigured as needed.

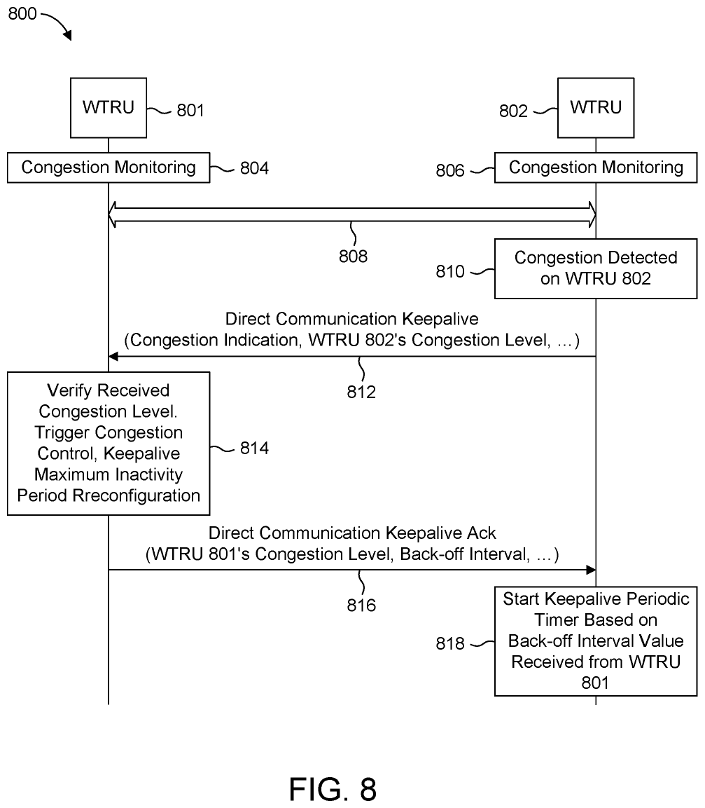

FIG. 8 is an example method of a reconfiguration based on received congestion level from a peer WTRU. The example includes link interval reconfiguration. Congestion monitoring may be performed at WTRU 801 at 804 and at WTRU 802 at 806. Communications between the two WTRUs is ongoing at 808. At 810, WTRU 802 detects a level of congestion. As illustrated in FIG. 8, WTRU 801 receives a keepalive message 812 from WTRU 802. In addition to the usual WTRU's behavior when such messages are received, WTRU 801 looks at the received congestion level of WTRU 802 at 814 and if congestion control is needed (e.g. based on provisioned QoS thresholds), the WTRU 801 may reconfigure the periodic timer to a larger value. The congestion level may indicate that congestion control is needed or is not needed anymore. A congestion indication may be specified indicating to which functionality congestion control should be applied, e.g. specific SM signaling or QoS reconfiguration of PC5. The trigger mechanism for sending a direct keepalive message acknowledge from WTRU 801 in FIG. 8 is that the WTRU 801 has evaluated the WTRU 802 congestion level in the direct communication Keepalive message 812 from WTRU 802. The evaluation at 814 indicates that, based on either or both of the congestion of WTRU 801 or WTRU 802, a back-off interval in the WTRU 801 transmitted keepalive acknowledge message 816 sent to WTRU 802 may be appropriate. This back-off interval has the effect that fewer periodic keepalive messages will be exchanged between WTRU 801 and WTRU 802 and thus congestion may be reduced.

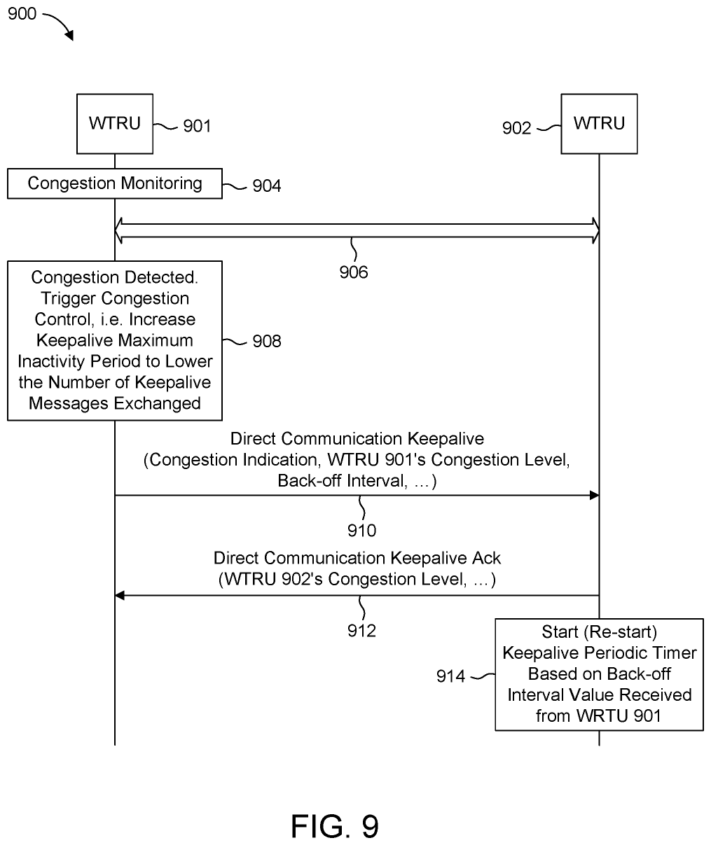

WTRU 801 may as well trigger congestion control and link reconfiguration based on its own congestion detection (i.e. without receiving any indication of congestion experienced by the peer WTRU). This is illustrated in FIG. 9 which depicts unicast link interval reconfiguration based on detected congestion level. The WTRU 901 monitors the congestion at 904. This congestion monitoring is observed by the WTRU 901 and is monitored locally within the WTRU 901. As such, the monitored congestion at 904 is congestion experienced by the WTRU 901 due to resources usage (i.e. observed and experienced by the WTRU). Normal communication between WTRU 901 and WTRU 902 is conducted at 906. At 908 WTRU 901 detects that congestion control is needed (e.g. based on provisioned QoS thresholds). WTRU 901 reconfigures the periodic keepalive message timer to a larger value by triggering the keepalive procedure and by including a congestion indication, its own congestion level, and a back-off timer value via direct communication keepalive message 910. The congestion indication indicates that congestion control is needed, for example, via use of the keepalive procedure. At 912, a direct communication keepalive acknowledge message is sent from WTRU 902 to WTRU 901 which includes WTRU 902 congestion level. At 914, a keepalive periodic timer based on the back-off interval value received from WTRU 901 is started or re-started in WTRU 902.

FIG. 9 illustrates reconfiguration using the keepalive procedure. However, the same mechanism (i.e. adding a congestion level and adapting the periodic interval) may be applied to other periodic procedures, such as privacy protection messages and re-keying messages. The WTRU may trigger the keepalive/Privacy protection/Re-Keying procedures (in addition to existing triggers). One possible trigger is that congestion may be detected and signaling traffic should be reduced (e.g. increase the interval) to reduce congestion. Another possible trigger may be that congestion is not detected anymore and a decrease in the interval may be indicated.

The WTRU may reconfigure the periodic intervals when the procedure needs to be run. For example, periodic intervals may be reconfigured because the periodic timer has expired or due to other triggers. In this case, if congestion is detected, the WTRU keeps track of ongoing congestion level and a new interval configuration to be applied. The new interval may execute the procedure when the running timer expires or because of other triggers. The WTRU then adds into the message the congestion level indication and new interval previously saved and sends the message to the peer WTRU to delay the next execution of the procedure.

Alternatively, it may be possible for the WTRUs to implicitly increase the value of their keep alive timer when the congestion is observed or advertised. The WTRU currently implicitly assumes that the PC5 link is not available when the keep alive message is not received at the expiry of the keep alive timer. It is proposed that during the congestion, the WTRU may increase (e.g. double) the keep alive value and would then only expect a keep alive message after the expiry of the increased keep alive timer. The value of the timer may be increased implicitly by the WTRU based on the level of the congestion.

Another congestion control technique is termed RAT offloading. RAT offloading may be used to reduce congestion on a RAT. To support this feature, WTRUs may first need to exchange their capabilities during the communication establishment procedure. If congestion is detected, for example, on the initiating WTRU, this WTRU may suggest to its peer WTRU to establish the link on another RAT. An example alternate RAT is either LTE-PC5 or 5G-PC5 either of which may be expected to be less or not congested. The initiating WTRU may suggest a list of RATs specific to the V2X service or V2X application, in a preference order. To establish a communication on another RAT, a peer WTRU selects a RAT from the list provided by the initiating WTRU and based on the preference order from the initiating WTRU.

RAT offloading may be done in different ways. Three alternatives are discussed herein:
A. When a communication is already established, using a Direct Communication Release message;
B. During the communication establishment, using a Direct Communication Reject message; and
C. While a communication is still ongoing, using a periodic message, such as keepalive, privacy protection or re-keying procedures.

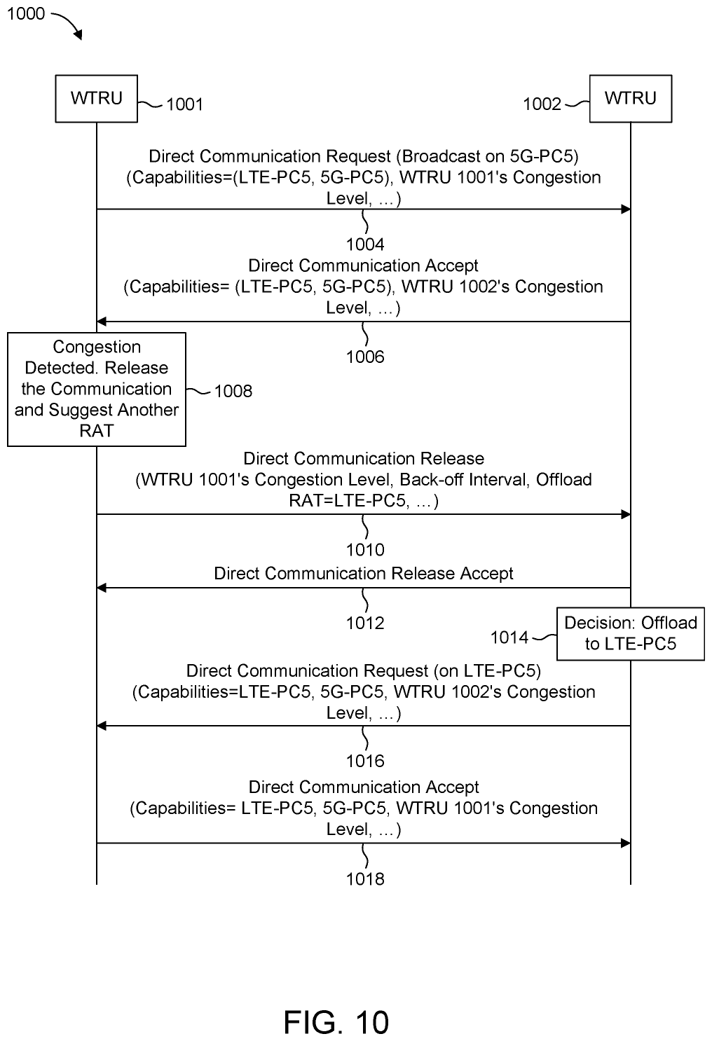

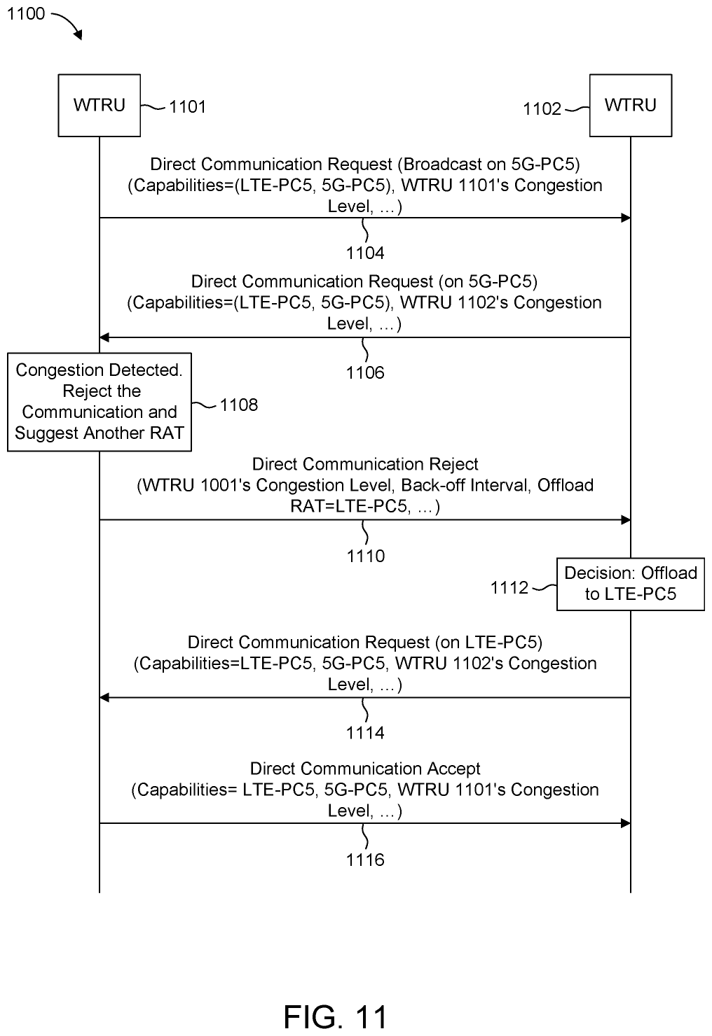

If Direct Communication Release or Direct Communication Reject messages are used, a peer WTRU may decide to wait before trying to re-establish a communication on the same RAT (using a back-off timer) or try immediately on a suggested RAT. The decision may be based on policies configured on the WTRU. Such policies may be dependent on the V2X service, urgency of sending data, and the like. This RAT offloading is illustrated in FIG. 10 using the Direct Communication Release message (alternative A) and in FIG. 11 using the Direct Communication Reject message (alternative B). As illustrated in FIG. 10 and FIG. 11, a first WTRU and a second WTRU exchange their capabilities during the communication setup.

Considering alternative A in FIG. 10 (i.e. Direct Communication Release message method of RAT offloading), capabilities are exchanged between WRTU 1001 and WTRU 1002 using DCR message 1004 and DCA message 1006. A communication is established on 5G-PC5. WTRU 1001 detects congestion at 1008 and decides to release the communication using a Direct Communication Release message 1010. This is followed by a Direct Communication Release Accept message 1012 in FIG. 10. Considering alternative B in FIG. 11 (i.e. Direct Communication Reject message method of RAT offloading), capabilities are exchanged using DCR message 1104 and DCR message 1106. The communication request is rejected due to congestion at 1108.

A back-off timer is provided on the Direct Communication Release message 1010 of FIG. 10 and the Direct Communication Reject message 1110 of FIG. 11, as described above and as illustrated in FIG. 10 and FIG. 11. In addition, the first WTRU suggests to the second WTRU to offload the communication to another RAT, such as LTE-PC5 in the Direct Communication Release message 1010 of FIG. 10 and in the Direct Communication Reject message 1110 of FIG. 11.

The second WTRU, upon receiving the release or reject message with an offloading RAT and a back-off timer, decides what it should do. The second WTRU may, immediately establish the communication with the first WTRU on the suggested offload RAT or start the back-off timer and at expiration, re-try to establish the communication on the current RAT which might not be congested anymore. In the examples of FIG. 10 and FIG. 11, the WTRU 1002 and WTRU 1102 decides to offload the communication to the suggested RAT, which is an LTE-PC5 at activity block 1004 in FIG. 10 and in activity block 1112 of FIG. 11.

In FIG. 10, once the decision to offload to the LTE-PC5 link is made, WTRU 1002 sends a DCR message 1016 on the LTE-PC5 communication link to WTRU 1001. The DCR message 1016 includes the congestion level of WTRU 1002. WTRU 1001 may then send a DCA message 1018 to WTRU 1002 on the LTE-PC5 communication link. The DCA message 1018 includes the congestion level of WTRU 1001.

In FIG. 11, once the decision to offload to the LTE-PC5 link is made, WTRU 1102 sends a DCR message 1114 on the LTE-PC5 communication link to WTRU 1101. The DCR message 1114 includes the congestion level of WTRU 1102. WTRU 1101 may then send a DCA message 1116 to WTRU 1102 on the LTE-PC5 communication link. The DCA message 1114 includes the congestion level of WTRU 1101.

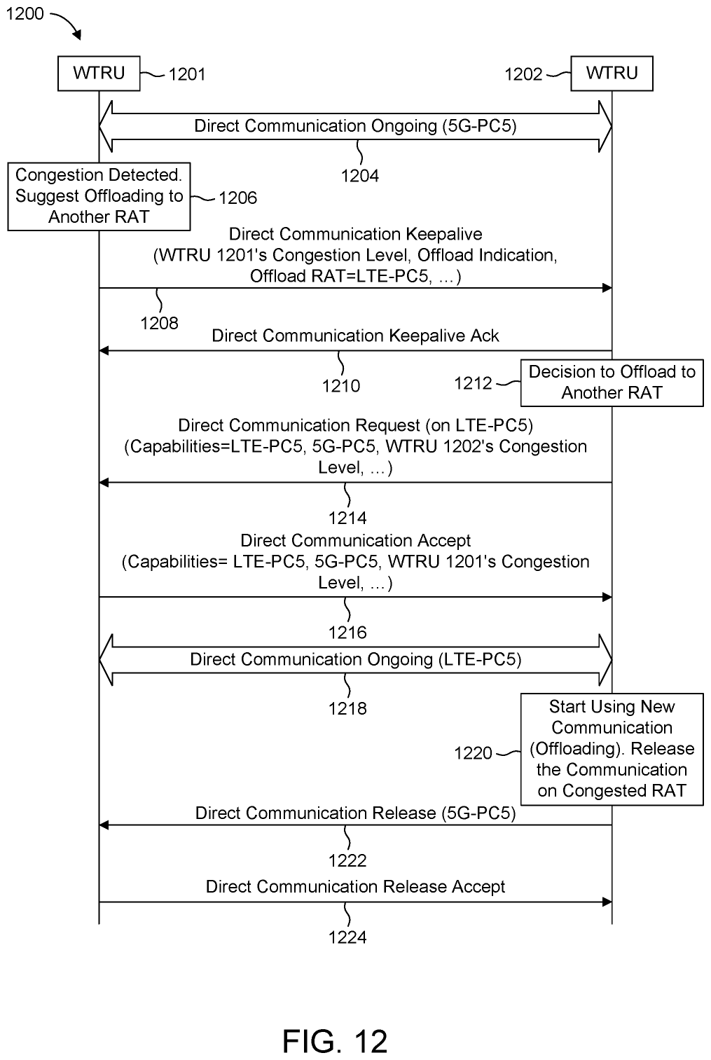

If a periodic message is used for an instruction to offload to another RAT, then the communication between WTRUs may be still ongoing. A periodic message may be used to trigger RAT offloading. This use of a periodic message may be to signal to the peer WTRU that congestion is detected and that offloading is suggested. A list of potential RATs in preferred order may be provided. Such a list may be provided, for example, by triggering of keepalive procedure. In this instance, the peer WTRU may decide to establish another communication on a suggested RAT, and if successful, offload all the traffic to this new communication path. The ongoing communication on the congested RAT may then be released. This is illustrated in FIG. 12.

In FIG. 12, a first WTRU 1201, has an ongoing direct communication link 1204 with a second WTRU 1202. At 1206, WTRU 1201 detects congestion and a decision to suggest offloading to another RAT is made. A Direct Communication Keepalive message 1208 is sent to WTRU 1202 which includes WTRU 1201's congestion level and an offload indication to a new RAT: LTE-PC5. WTRU 1202 sends a direct Keepalive Acknowledgement message 1210. At 1212, WTRU 1202 makes a decision to offload to another RAT based on the information received in message 1208. WTRU 1202 sends a DCR to WTRU 1202 on the LTE-PC5 Rat indicating the congestion level of WTRU 1202. WTRU1201 accepts the DCR by sending a DCA 1216 indicating WTRU 1201's congestion level. The two WTRUs communicate on the LTE-PC5 communication link at 1218. After successful ongoing communication on the LTE-PC5 RAT, WTRU 1202 may start offloading the communication established on the originally used 5G-PC5 RAT at step 1220. WTRU 1202 sends a Direct Communication Release message 1222 to WTRU 1201 to release the 5G-PC5 RAT link. WTRU 1201 responds to the release request using a Direct Communication Release Accept at 1224. As a result, offloading of the 5G-PC5 link is accomplished.

Alternatively, the peer WTRU may decide to release the ongoing congested communication immediately, before trying to establish communication on another RAT. The decision may be based on policies configured on the WTRU considering such factors as the V2X service, the urgency of sending data, and the like.

As previously discussed, an ongoing communication may become congested, that is, the RAT in use may become congested. A WTRU may decide to offload a communication to another RAT. The decision (as for instances discussed above with Release and Reject) may be based on various factors, such as policies for the V2X application using this communication, peer WTRU's capabilities such as having access to other RATs, the congestion of an available alternative RAT, and the like.

The WTRU that decided to apply congestion control measures may reverse these measures when no congestion is observed anymore. Congestion may be relieved on the WTRU itself or on its peer. In this instance, existing communications may be reconfigured with the regular intervals' value. Communications may as well be offloaded back to the preferred PC5 RAT.

A WTRU may be provisioned to enable/disable the congestion control feature. If the congestion control is enabled, related parameters may be provisioned. For example, a congestion control may be enabled or disabled. The number of communications between 2 peers may be set to some allowed limit before declaring a congestion ON indication. One example limit for a congestion ON decision may be 10 communications between peers. The number of communications allowed before declaring congestion OFF condition/status may be set to indicate when a congestion condition/status may be turned off. One example limit for a congestion OFF condition/status from a congestion ON condition/status may be a reduction of the number of communications between peers to 7. A WTRU may be provisioned with a Table per V2X application ID (e.g. PSID or ITS-AID) to indicate congestion levels with a QoS profile to be configured per QoS level and a Range. In addition, the table may be a list of supported RATs in a preferred order for offloading.

In an additional approach to communicating a congestion level from an initiation WTRU to a peer WTRU, the initiating WTRU can limit the responses to an offer for communication establishment with peer WTRUs. Here, an initiating WTRU may transmit a set of requirements for a peer WTRU to meet before accepting a link establishment offered by an initiating WTRU. The initiating WTRU may include such a requirement list along with a link establishment request sent to one or more peer WTRUs along with the congestion level of the initiating WTRU.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to Figures. 1A-1D.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the methods, apparatuses and systems provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM″)) or non-volatile (e.g., Read-Only Memory (ROM″)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Moreover, as used herein, the term “set” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1-20. (canceled)

21. A method comprising:
receiving by a peer wireless transmit/receive unit, WTRU, from an initiating WTRU a first message, the first message comprising an indication of congestion level experienced by the initiating WTRU;
determining by the peer WTRU to establish a communication with the initiating WTRU;
transmitting a second message to the initiating WTRU, the second message comprising an indication of congestion level of the peer WTRU; and
establishing the communication with the initiating WTRU.

22. The method of claim 21, wherein receiving the first message comprises receiving a direct communication request message, and wherein transmitting the second message to the initiating WTRU comprises transmitting a direct communication accept message.

23. The method of claim 21, wherein determining to establish a communication with the initiating WTRU comprises determining to establish the communication based on the indication of congestion level experienced by the initiating WTRU.

24. The method of claim 21, further comprising:
receiving by the peer WTRU from the initiating WTRU a third message instructing a release of the established communication with the initiating WTRU.

25. The method of claim 24, wherein the third message comprises a direct communication release message including a revised indication of congestion level experienced by the initiating WTRU and a back-off interval value.

26. The method of claim 24, further comprising:
transmitting to the initiating WTRU a fourth message accepting the instruction of a release of the established communication with the initiating WTRU.

27. The method of claim 26, wherein the fourth message comprises a direct communication release accept message.

28. The method of claim 26, further comprising:
using a back-off interval value received with the third message; and
re-establishing communication with the initiating WTRU after expiration of the back-off interval.

29. A peer wireless transmit/receive unit, WTRU, comprising circuitry including a transmitter, a receiver, a processor, and memory, the WTRU configured to:
receive from an initiating WTRU a first message, the first message comprising an indication of congestion level experienced by the initiating WTRU;
determine to establish a communication with the initiating WTRU;
transmit a second message to the initiating WTRU, the second message comprising an indication of congestion level of the peer WTRU; and
establish the communication with the initiating WTRU.

30. The peer WTRU of claim 29, wherein the first message comprises a direct communication request message, and the second message comprises a direct communication accept message.

31. The peer WTRU of claim 29, wherein the determination to establish a communication with the initiating WTRU is based on the indication of congestion level experienced by the initiating WTRU.

32. The peer WTRU of claim 29, further configured to:
receive from the initiating WTRU a third message instructing a release of the established communication with the initiating WTRU.

33. The peer WTRU of claim 32, wherein the third message comprises a direct communication release message that includes a revised indication of congestion level experienced by the initiating WTRU and a back-off interval value.

34. The peer WTRU of claim 32, further configured to:
transmit to the initiating WTRU a fourth message accepting the instruction of a release of the established communication with the initiating WTRU, the fourth message comprising a direct communication release accept message.

35. The method of claim 34, further configured to:
start a back-off interval using the back-off interval value received in the third message; and
re-establish communication with the initiating WTRU after expiration of the back-off interval.

36. A method comprising:
transmitting a communication request message to a peer wireless transmit/receive unit, WTRU, the communication request message comprising an indication of congestion level experienced by the WTRU;
receiving an acceptance message comprising an indication of congestion level of the peer WTRU;
establishing the communication with the peer WTRU;
transmitting a communication release message instructing a release of the established communication with the peer WTRU, the communication release message comprising a back-off interval value;
receiving an acceptance of the communication release message;
re-establishing communication with the peer WTRU after expiration of the back-off interval.

37. The method of claim 36, wherein transmitting the communication request message comprises transmitting a direct communication request message, and wherein receiving an acceptance message comprises receiving a direct communication accept message.

38. The method of claim 36, wherein transmitting a communication release message further comprises transmitting a revised indication of congestion level experienced by the WTRU.

39. The method of claim 38, wherein transmitting a communication release message is based on the revised indication of congestion level experienced by the WTRU.

40. The method of claim 36, wherein establishing the communication with the peer WTRU comprises establishing a vehicle to everything communication exchange with the WTRU.
